(19) United States
(12) Patent Application Publication
(10) Pub. No.: US 2005/0183990 A1
(43) Pub. Date: Aug. 25, 2005

(54) Textile identification system with RFID tracking

(76) Inventor: Bradford G. Corbett JR., Fort Worth, TX (US)

Correspondence Address: Charles D. Gunter, Jr.;Whitaker, Chalk, Swindle & Sawyer, LLP, 3500 City Center Tower II, 301 Commerce Street, Fort Worth, TX, 76102, US

(21) Appl. No.: 11/032,963

(22) Filed: Jan. 11, 2005

Related U.S. Application Data
(60) Provisional application No. 60/535,932, filed on Jan. 12, 2004.

(51) Int. Cl. B07C 5/02

(52) U.S. Cl. 209/3.3

(57) ABSTRACT

An asset tracking system is provided, having particular usefulness in connection with the marking and tracking of textile goods such as garments and linens. Interrogation of RFID tags located on various garment parts insures that the parts are properly tracked, identified and matched.

### CROSS REFERENCE TO RELATED APPLICATION

The present U.S. Patent Application claim priority from earlier filed U.S. Provisional Patent Application: Ser. No. 60/535,932, filed Jan. 12, 2004 “Textile Identification System with with RFID Tracking.”

### BACKGROUND OF THE INVENTION

1. Field of the Invention

The present invention relates to radio frequency identification (RFID) systems for asset sorting and matching and tracking, and to one embodiment of such a system for marking and identifying objects such as garments, textiles and linens.

2. Description of the Prior Art

There exists a need in a number of different industries for improvements in the way that items are marked and tracked. This is especially true where a large number of items must be separated, identified, counted and sorted. One example is the textile service industry, wherein soiled garments or linens are returned in large unsorted groups for cleaning and sorting. Present day means for solving this problem cover a diverse spectrum. One solution uses manual workers who sequentially sort amongst the many items, picking single items manually and identifying the items visually. This solution is unsatisfactory because it is both slow and expensive, due to the high reliance on manual labor, and because mistakes occur in matching and sorting the items.

There are numerous coding and sorting applications in the textile services industry whose requirements are not efficiently met by bar codes or optical readers. For example, identification schemes which relay upon reading bar codes or other optical indicia are not well suited for use in the sorting of flat goods such as napkins, tablecloths, towels and bed linen items. These items, which range in size from very small to large, are typically processed in random orientations which are problematical for line of sight reading devices. There are other barriers and obstacles to the accurate machine identification and automated counting and sorting of goods and bulk garments of the type encountered in the linen and textile industries. The lack of a viable coding and sorting solution for this segment of the textile services industry has resulted in high labor costs, lack of stock control, and reduced profits.

On a simpler scale, a problem is often encountered by individual consumers in receiving their properly sorted and matched laundry, whether provided by an industrial establishment such as a dry cleaner, or by the individual's own resources at home. For example, the various parts of dark colored suits are often hard to match, particularly under certain lighting conditions. It would be advantageous to provide a marking and identification system for individual consumers, as well as laundry establishments, which would positively identify and match the consumers clothing parts, without any likely possibility of mistake.

The need for a solution to the above described problems is amplified in the need for a technique which would provide for the machine readable marking of rental textiles. Such a technique would be extremely valuable for inventory control at commercial laundries and other installations where large quantities of similar-looking materials must be handled in a high speed manner. Currently, only a small fraction of the rental textile industry uses machine readable coding. Most coding currently used to uniquely identify a rental textile item is simply text printed on a heat-sealed label attached to the item, and requires the presence of a human operator.

There are several reasons why the textile rental industry has only slowly adopted machine readable identification technology. Historically, the preferred machine readable marking schemes for textiles were bar-code based systems. Bar codes continue to be the most commonly available type of machine readable marking in use today. However, tests of identification systems in actual laundries have shown that bar coding is not a robust coding technology on textile items. Bar codes are highly susceptible to degradation through both soiling and wear. Furthermore, due to the precise spatial information required for a bar code, such as line width and spacing, any warping of the label can result in high reading error rates. Finally, bar codes require line-of-sight and, therefore a specific orientation, with respect to the detector, both of which are difficult conditions to satisfy under typical large scale laundry conditions.

A need thus exists for a marking and tracking technology that has the ease of use and the low cost associated with bar codes, and yet is more robust and tolerant of the conditions found in large scale commercial laundries and other similar environments.

A need also exists for a garment, textile and linen identification system which is suitable for use by individual consumers in marking clothing items in the home.

### SUMMARY OF THE INVENTION

The present invention has as one object to provide a marking an identification system for garments which does not suffer from the line of sight and soiling problems associated with bar codes.

Another object of the invention is to provide such a marking an identification system which is relatively inexpensive, both from initial cost and associated maintenance costs, and therefore is economical to implement for even the rental textile industry.

These and other objects of the invention are accomplished by providing a marking and identification system which includes the steps of providing a RFID of a suitable size and configuration for the particular task at hand; attaching at least one such RFID to the garment or textile to be marked and identified; and interrogating the RFID by means of a suitable reader to thereby obtain identifying information about the garment or textile.

Preferably, the RFID is a tag which is read by an associated reader. In some instances, the tag contains information which is alterable by the reader. For garment applications, the RFID is preferably encapsulated in an encapsulating material which renders it impervious to normal environmental influences such as water, cleaning solvents temperature and pressure which are encountered in laundry and dry cleaning operations. In one particularly preferred embodiment of the invention, the RFID is encapsulated in a liquid resin which is subsequently cured. In another embodiment of the invention, the electrical components of the RFID are physically isolated from the environment by enclosing the components between top and bottom layers of a heat and shock resistant material.

In one embodiment of the invention, a method of marking and identifying garment items is shown in which a wireless radio frequency identification device is manufactured by (1) providing a substrate having conductive lines formed thereon, the conductive lines comprising an antenna; (2) conductively bonding an integrated circuit chip and a battery to the conductive lines on the substrate; (3) providing a liquid resin which is compatible with the substrate, integrated circuit chip and battery and applying the liquid resin onto the substrate effective to encapsulate the chip and battery within the liquid resin on the substrate; (4) after the applying, curing the liquid resin mixture into a solid mass which encapsulates the chip and battery and comprises a wireless radio frequency identification device; and (5) attaching the wireless radio frequency device to the garment. The radio frequency identification device is subsequently interrogated by means of a suitable reader to thereby obtain identifying information about the garment.

Additional objects, features and advantages will be apparent in the written description which follows.

### BRIEF DESCRIPTION OF THE DRAWINGS

FIG. 1 is a block diagram of a wireless communication system which includes a tag for placement on a garment or textile and an associated reader.

FIG. 2 is a front, partly schematic view of a wireless communication device of the type used in practicing the invention with the cover layer removed for ease of illustration.

FIG. 3 is a simplified, perspective view of a portion of a user's profile, showing a garment.

### DETAILED DESCRIPTION OF THE INVENTION

The system of the invention uses wireless radio frequency identification devices (RFID's) to mark, track and identify such objects as garments, textiles and linens. RFID technology will first be described in general terms before turning to a specific end application of the invention. Whereas RFID's were, in the past, cost prohibitive, such devices can now be purchased commercially for on the order of 20 to 30 cents apiece, making them suitable for the purposes of the present invention. RFID tags are now well-known and typically include an integrated circuit (IC) that is operatively coupled to an antenna (the tag antenna). The tag may also have a battery, or it may have no battery and may instead obtain energy from an external reader. RFID tags without batteries may be preferred for applications in which lower cost is a dominant factor, and RFID tags with batteries may be preferred for applications in which a longer read range is preferred. Either or both may be used in conjunction with the present invention. The RFID tags of the present invention preferably resonate in the UHF or microwave frequency band, either of which enables an RFID reader to interrogate the tags from a sufficiently long read range to be useful.

The IC associated with an RFID tag typically includes a certain amount of memory in which a tag identifier is stored, and perhaps other information related to the tag, and/or the item or items with which the tag is to be associated. When an RFID reader (also known as an interrogator, either of which may read or write information to an RFID tag) transmits energy via its reader antenna to interrogate the RFID tag, the tag responds with information from which the reader can obtain the RFID tag identifier or other information. The data, identifier, or information obtained by the RFID reader may then be compared to entries in a database of identifiers or to information associated with that RFID tag. In that manner, information regarding an RFID-tagged item may be obtained, updated, and provided to a user, and/or written to an RFID tag, perhaps even in real-time.

Presently available RFDI systems operate in both low frequency (less than 100 megahertz) and high frequency (greater than 100 megahertz) modes. Unlike their low-frequency counterparts, high-frequency tags can have their data read at distances of greater than one meter, even while closely spaced together. New data can also be transmitted to the tags.

In the low-frequency system, an integrated circuit sends a signal to an oscillator, which creates an alternating current in the reader's coil. That current, in turn, generates an alternating magnetic field that serves as a power source for the tag. The field interacts with the coil in the tag, which induces a current that causes charge to flow into a capacitor, where it is trapped by the diode. As charge accumulates in the capacitor, the voltage across it also increases and activates the tag's integrated circuit, which then transmits its identifier code. High and low levels of a digital signal, corresponding to the ones and zeros encoding the identifier number, turn a transistor on and off. Variations in the resistance of the circuit, a result of the transistor turning on and off, cause the tag to generate its own varying magnetic field, which interacts with the reader's magnetic field. In this technique, called load modulation, magnetic fluctuations cause changes in current flow from the reader to its coil in the same pattern as the ones and zeros transmitted by the tag. The variations in the current flow in the reader coil are sensed by a device that converts this pattern to a digital signal. The reader's integrated circuit then discerns the tag's identifier code.

In the high-frequency system, an integrated circuit sends a digital signal to a transceiver, which generates a radio-frequency signal that is transmitted by a dipole antenna. The electric field of the propagating signal gives rise to a potential difference across the tag's dipole antenna, which causes current to flow into the capacitor; the resulting charge is trapped by the diode. The voltage across the capacitor turns on the tag's integrated circuit, which sends out its unique identifier code as a series of digital high- and low voltage levers, corresponding to ones and zeros. The signal moves to the transistor. The transistor gets turned on or off by the highs and lows of the digital signal, alternately causing the antenna to reflect back or absorb some of the incident radio frequency energy from the reader. The variations in the amplitude of the reflected signal, in what is called backscatter modulation, correspond to the pattern of the transistor turning on and off. The reader's transceiver detects the reflected signals and converts them to a digital signal that is relayed to the integrated circuit, where the tag's unique identifier is determined.

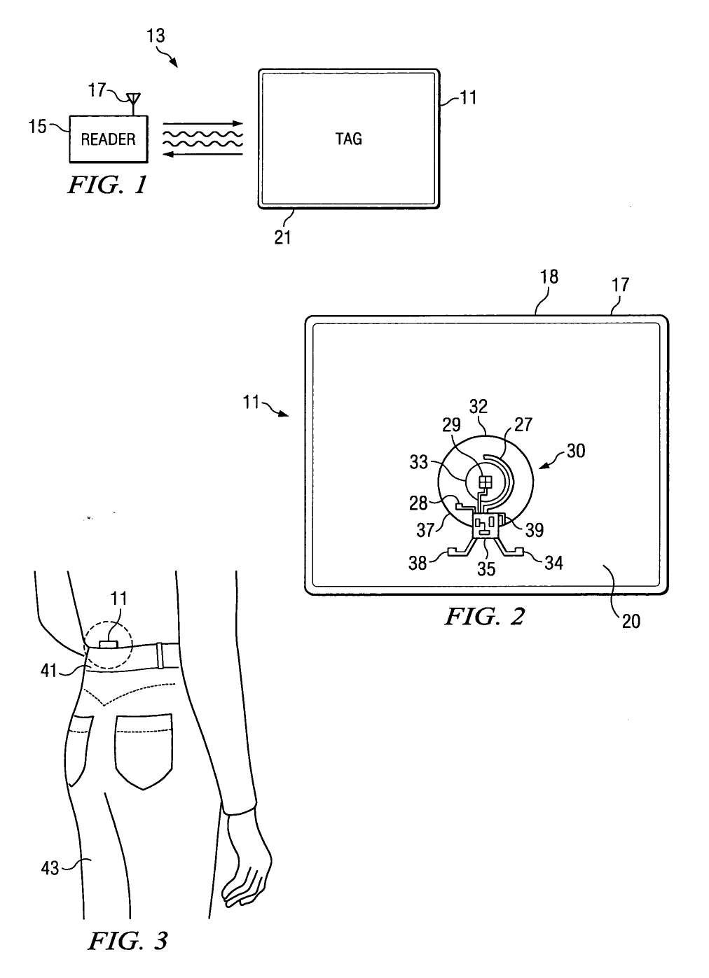

Referring now to FIG. 1, a preferred embodiment of the marking, tracking and sorting system of the invention will now be described. FIG. 1 shows, in block diagram fashion, a remote intelligent communication device or wireless communication device 11 which comprises part of a communication system 13. The remote intelligent communication device is capable of functions other than the identifying function of a radio frequency identification device. A preferred embodiment of the remote intelligent communication device includes a processor.

The communication system 13 includes an interrogator unit or reader 15. The wireless communication device 11 communicates via wireless electronic signals, such as radio frequency (RF) signals, with the reader 15. Radio frequency signals including microwave signals are utilized for communications in a preferred embodiment of communication system 13. The communication system 13 includes an antenna 17 coupled to the reader 15.

Referring to FIG. 2, one form of the wireless communication device 11 which is useful for purposes of the present invention is shown. The device 11 is of the general type shown in issued U.S. Pat. No. 6,666,379, although it will be understood that other commercially available “tags” can be utilized, as well. The device 11 includes an insulative substrate or layer of supportive material 18. Example materials for the substrate 18 comprise polyester, polyethylene or polyimide film having a thickness of 3-10 mils.

Substrate 18 provides a first or lower portion of a housing for the wireless communication device 11 and defines an outer periphery 21 of the device 11. Substrate 18 includes a plurality of peripheral edges 17. A support surface 20 is provided to support components and circuitry formed in later processing steps upon substrate 18. In FIG. 2, support surface 20 comprises an upper surface of the layer shown.

A patterned conductive trace 30 is formed or applied over the substrate 18 and atop the support surface 20. A preferred conductive trace 30 comprises printed thick film (PTF). The printed thick film comprises silver and polyester dissolved into a solvent. One manner of forming or applying the conductive trace 30 is to screen or stencil print the ink on the support surface 20 through conventional screen printing techniques. The printed thick film is preferably heat cured to flash off the solvent and UV cured to react UV materials present in the printed thick film.

The conductive trace 30 forms desired electrical connections with and between electronic components which will be described below. In one embodiment, substrate 18 forms a portion of a larger roll of polyester film material used to manufacture multiple devices 10. In such an embodiment, the printing of conductive trace 30 can take place simultaneously for a number of the to-be-formed wireless communication devices.

The illustrated conductive trace 30 includes conductive lines and patterns, such as an electrical connection 28, a first connection terminal 29 and a second connection terminal 27. Conductive trace 30 additionally defines transmit and receive antennas 32, 34 in one embodiment of the invention. Antennas 32, 34 are suitable for respectively transmitting and receiving wireless signals or RF energy. Transmit antenna 32 constitutes a loop antenna having outer peripheral edges 37. Receive antenna 34 constitutes two elongated portions individually having horizontal peripheral edges 38.

Other antenna constructions are also possible. For example, both transmit and receive operations can be implemented with a single antenna in alternative embodiments of the present invention. Both antennas 32, 34 preferably extend or lie within the confines of peripheral edges 17 and outer periphery 21 and define a plane.

One embodiment of a wireless communication device 11 includes a power source 33, an integrated circuit chip 35, and capacitor 39. Power source 33, capacitor 39, and integrated circuit chip 35 are provided and mounted on support surface 20 and supported by substrate 18. The depicted power source 33 is disposed within transmit antenna 32 of wireless communication device 11. Capacitor 39 is electrically coupled with loop antenna 32 and integrated circuit 35 in the illustrated embodiment.

Power source 33 provides operational power to the wireless communication device 11 and selected components therein, including integrated circuit 35. In the illustrated embodiment, power source 33 comprises a battery. In particular, power source 33 is preferably a thin profile battery which includes first and second terminals of opposite polarity. More particularly, the battery has a lid or negative (i.e., ground) terminal or electrode, and a can or positive (i.e., power) terminal or electrode.

It is important for purposes of the present invention that the RFID be heat and pressure tolerant. In order to achieve this result, the electronic components are ultimately encapsulated, either chemically or physically, in a protective barrier type material or materials. In the embodiment illustrated in FIGS. 1 and 2, conductive epoxy is applied over desired areas of support surface 20 using conventional printing techniques, such as stencil or screen printing, to assist in component attachment described just below. Alternately, solder or another conductive material is employed instead of conductive epoxy. The power source 33 is provided and mounted on support surface 20 using the conductive epoxy. Integrated circuit 35 and capacitor 39 are also provided and mounted or conductively bonded on the support surface 20 using the conductive epoxy.

Integrated circuit chip 35 includes suitable circuitry for providing wireless communications. For example, in one embodiment, integrated circuit chip 35 includes a processor, memory, and wireless communication circuitry or transponder circuitry for providing wireless communications with reader 15.

One embodiment of transponder circuitry includes a transmitter and a receiver respectively operable to transmit and receive wireless electronic signals. In particular, transponder circuitry is operable to transmit an identification signal responsive to receiving a polling signal from reader 15. Specifically, the processor is configured to process the received polling signal to detect a predefined code within the polling signal. Responsive to the detection of an appropriate polling signal, the processor instructs transponder circuitry to output an identification signal. The identification signal contains an appropriate code to identify the particular device 11 transmitting the identification signal in certain embodiments. The identification and polling signals are respectively transmitted and received via antennas 32, 34 of the device 11.

First and second connection terminals 29, 27 are coupled to the integrated circuit 35 by conductive epoxy in accordance with a preferred embodiment of the invention. The conductive epoxy also electrically connects the first terminal of the power source 33 to the first connection terminal 29.

Subsequently, conductive epoxy is dispensed relative to perimetral edge 37 and electrically connects perimetral edge with connection terminal 27. In the illustrated embodiment, perimetral edge defines the can of the power source 33. The conductive epoxy connects the positive terminal of the power source 33 to connection terminal 27. The conductive epoxy is then cured. Thus, the integrated circuit and battery are conductively bonded relative to the substrate and to the conductive lines of trace.

An encapsulant, such as encapsulating epoxymaterial, is subsequently formed following component attachment. In one embodiment, the encapsulant is provided over the entire support surface 20. Such encapsulates or envelopes the antennas 32, 34, integrated circuit 35, power source 33, conductive circuitry 30, capacitor 39, and at least a portion of the support surface 20 of substrate 18. The encapsulant operates to insulate and protect the components (i.e., antennas 32, 34, integrated circuit 35, power source 33, conductive circuitry 30 and capacitor 39).

A flowable encapsulant is preferably applied over substrate 18 and subsequently cured following the appropriate covering of the desired components. In the preferred embodiment, such encapsulant constitutes a two-part off the shelf epoxy which typically includes fillers such as silicon and calcium carbonate. The preferred two-part epoxy is sufficient to provide a desired degree of flexible rigidity. Specifically, the preferred epoxy comprises a two-component system having a liquid resin material and a liquid hardener material. The resin typically constitutes three times the volume of the hardener within the liquid mixture from which the two-part system cures. Adequate and complete mixing of the resin/hardener two-component epoxy system occurs prior to dispensing or otherwise providing the liquid encapsulant atop the substrate, chip, and battery. Other encapsulant materials of the insulative layer can also be used in accordance with the present invention. Such encapsulation would preferably occur from fabrication of multiple device patterns formed on a single substrate sheet, and then cutting individual devices 11 from the sheet after encapsulation and cure.

FIG. 3 shows a completed tag 11 which has been attached to a garment, in this case the waist lining 41 of a pair of suit pants 43. The tag 11 allows the pants to be properly tracked, sorted and matched to the mating suit coat at, for example, a dry cleaners. The tag 11 can be attached by, e.g., sewing in a hem or liner of a garment, or by gluing or otherwise a fixing the tag to the garment.

In addition to the previously described chemical encapsulation method, it will be understood that the RFID's of the invention can be physically or mechanically isolated from various environmental factors, as well. The RFID's of the invention must be capable of existing in a variety of environments and must therefore be encapsulated or isolated for durability against shock, fluids, dust or dirt, and the like. Although a variety of tags are commercially available which will suffice in most home environments, they must be isolated or protected to withstand the high temperature environment of, for example, a dry cleaning operation.

In additional envisioned embodiments of the invention, the electrical components are physically or mechanically isolated from the environment by providing the substrate with a top and bottom comprised of substantially flexible, high temperature resistant materials. Preferably, the substrate with its electrical components are housed in a top and bottom layers comprised of a substantially flexible polymeric material such as a polyimid, for example, Kapton™. In one embodiment of the invention, the substrate is joined to top and bottom layers by means of a thermally resistant, substantially flexible silicone encapsulant on one side and with a high temperature adhesive on the other side. In a preferred embodiment, the silicone encapsulant can comprise Stycast™ 4952 (manufactured by Emerson & Cuming Specialty Polymers). The high temperature adhesive can comprise, for example, 3M.RTM.-9460PC, having a temperature rating in the range of 500° F.

Physically isolating the tag electronic components with thermally resistant materials provides a tag which exhibits superior thermal and shock resistance. The tag 11 is also substantially flexible and can be provided in thickness ranges of about 0.020 in. to 0.040 inches. Such tags should be capable of withstanding temperature ranges of approximately −40° C. to 300° C. The RFID tags can also be cycled to and from the survival temperature and the operating temperature range without adversely affecting the performance characteristics of the tags. The tags may thus be employed in various high temperature industrial environments and/or operations, such as laundry and dry cleaning operations, which has not been possible with prior art tags.

An invention has been provided with several advantages. The RFID tags used in the system of the invention provide improved readability and reliability over line of sight identification systems such as those utilizing bar codes or optic readers. The tags are readable despite various orientations of the garment or linen being handled. The tags can withstand both shock and temperature cycles likely to be encountered in the intended environment of use. The tags are reasonably priced, allowing them to be economically incorporated into, for example, the pants and coat of a dress suit.

While the invention has been shown in only one of its forms, it is not thus limited but is susceptible to various changes and modifications without departing from the spirit thereof.

1. A method of marking and identifying a garment, the method comprising the steps of:
providing a RFID of a suitable size and configuration for a particular task at hand;
attaching at least one such RFID to the garment to be marked and identified; and
interrogating the RFID by means of a suitable reader to thereby obtain identifying information about the garment.

2. The method of claim 1, wherein the RFID is a tag which is read by an associated reader.

3. The method of claim 2, wherein the tag contains information which is alterable by the reader.

4. The method of claim 1, wherein the RFID is encapsulated in an encapsulating material which renders is impervious to normal environmental influences.

5. The method of claim 4, wherein the RFID is encapsulated in a liquid resin which is subsequently cured.

6. The method of claim 5, wherein the RFID is encapsulated in an epoxy resin.

7. The method of claim 1, wherein the RFID contains sensitive electrical components and wherein the sensitive electrical components are physically isolated from the environment by enclosing the components in a top and bottom layer of heat resistant polymeric materials.

8. A method of marking and identifying garment items, the method comprising the steps of:
fabricating a wireless radio frequency identification device comprising:
providing a substrate having conductive lines formed thereon, the conductive lines comprising an antenna;
conductively bonding an integrated circuit chip and a battery to the conductive lines on the substrate;
providing a liquid resin which is compatible with the substrate, integrated circuit chip and battery and applying the liquid resin onto the substrate effective to encapsulate the chip and battery within the liquid resin on the substrate;
after the applying, curing the liquid resin mixture into a solid mass which encapsulates the chip and battery and comprises a wireless radio frequency identification device; and
attaching the wireless radio frequency device to the garment.

9. The method of claim 8, wherein the liquid resin is a liquid epoxy mixture which is substantially void of any liquid material other than a hardener and the resin.
